(19) United States
(12) Patent Application Publication
(10) Pub. No.: US 2010/0078991 A1
(43) Pub. Date: Apr. 1, 2010

(54) PERFORMANCE-OPTIMIZED SAFETY BRAKE

(75) Inventors: Dieter Maischak, Weisendorf (DE); Volker Schmitt, Erlangen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/524,581

(22) PCT Filed: Feb. 4, 2008
(86) PCT No.: PCT/EP2008/051346

§ 371 Date: Jul. 27, 2009

(30) Foreign Application Priority Data
Feb. 6, 2007 (DE) 10 2007 006 725.0

(51) Int. Cl. B60T 8/17; B60T 8/66

(52) U.S. Cl. 303/168

(57) ABSTRACT

A brake device for braking a vehicle has a brake surface which is rotationally fixedly connected to a wheel axle of the vehicle, a brake lining which can be pressed with a braking force against the brake surface and an actuating element coupled to a control unit, for generating the braking force. The control unit is connected to a speed sensor for measuring a speed of the vehicle and is set up to adjust the braking force in dependence on the speed. The brake device has as high a braking force as possible which is introduced into the brake surfaces. The control unit is coupled to the actuating element via a device for continuous pressure adjustment, so as to enable a continuous adaptation of the braking force to the present speed in each case. The braking force is advantageously adjusted inversely proportionally to the speed of the vehicle.

The invention relates to a brake device for braking a vehicle which has a brake surface which is connected to a wheel axle of the vehicle so as to rotate with it, having a brake lining which can be pressed against the brake surface with a braking force, and an actuator element which is coupled to a control unit and has the purpose of generating the braking force, wherein the control unit is connected to a speed sensor for sensing a speed of the vehicle, and is configured to adjust the braking force as a function of the speed.

The invention also relates to a method for braking a vehicle in which the speed of the vehicle is sensed by a speed sensor, and a control unit which is connected to the speed sensor presses, as a function of the speed, a brake lining with a braking force against a brake surface which is connected to a wheel axle of the vehicle so as to rotate with it.

Such a brake device and such a method are already known from DE 38 03 639 C2. The pneumatic brake device which is described in said document has a control loop for adjusting the braking force of a service brake as a function of measurement variables. These measurement variables comprise speed values of the vehicle which is to be braked and which are generated by axle rotational speed sensors. Alternatively, a measuring sensor is provided which generates the respective reciprocal value of the speed values and transmits it to the control unit.

DE 199 46 679 C2 also discloses a service brake which has a control loop and is configured to adjust the braking force as a function of the speed. Furthermore, the brake system described in said document comprises a pressure transmitter which makes it possible to control small volume flows which are converted into large volume flows by the pressure transmitter. For this purpose, an actuation pressure can be applied to an actuation input of the pressure transmitter, in which case the pressure transmitter boosts the actuation pressure as a function of a pilot control pressure. The outlet of the pressure transmitter is connected to brake cylinders to which the boosted actuation pressure is applied in this way.

In the case of friction brakes, the power input p into the friction elements is speed-dependent and can be described by the equation p=F*v, where F is the braking force which is applied to the friction elements and v is the speed of the vehicle which is to be braked. The power input p is made essentially into the brake disc which is connected to a wheel axle of the vehicle so as to rotate with it. However, an excessively large power input p leads to thermal stresses in the friction ring of this brake disc. When the braking power is increased excessively, these stresses can lead to fractures in the brake disc and to premature wear thereof. In particular, the input of braking power peaks is to be avoided as far as possible.

In the case of high speed trains, the braking force is generally reduced incrementally to a relatively low value in the upper speed range in order to limit the input braking power to a reliable value. For example, according to the prior art it is therefore customary to switch the braking force over incrementally to a relatively low value when a maximum speed of the vehicle is exceeded, for example when 200 km/h is exceeded, with the result that said braking force is lower above 200 km/h than below 200 km/h. In this way, the input braking power is reduced. However, the incremental lowering of the braking force does not make available the maximum permissible braking power which can still just be generated without damaging the brake disc.

The object of the invention is therefore to make available a brake device and a method of the type mentioned at the beginning with which the largest possible braking force is applied to the brake surface without irreversible damage occurring to the brake surface.

The invention solves this problem on the basis of the brake device mentioned at the beginning by virtue of the fact that the control unit is coupled to the actuator element via means for continuously adjusting the pressure, with the result that continuous adaptation of the braking force to the respectively prevailing speed is made possible.

On the basis of the method mentioned at the beginning, the invention solves this problem by virtue of the fact that the braking force is adapted continuously to the speed by means for continuously adjusting the pressure, when a threshold speed is exceeded.

According to the invention, means for continuously adjusting the pressure are used to adjust the braking force. These means permit continuous output pressures to be adjusted as a function of their input signals or control signals. In this way, owing to their output-side coupling to the actuator element it is possible to generate any desired time profiles of the braking force F. According to the prior art, permanently actuated solenoid valves are used in each case, with the result that incremental lowering of the braking force must inevitably occur at high speeds.

The means for continuously adjusting the pressure are advantageously what is referred to as an analogue converter. Such analogue converters are known, for example, as electro-pneumatic control valves with the product name BRP-IC/EAP41 from the German company Bosch Rexroth AG.

In contrast to this, the means for continuously adjusting the pressure comprise binary solenoid valves which are actuated by pulse width modulation. Any desired pressures can be set at the outlet of the binary, that is to say digital, solenoid valves averaged over time by the actuation in the form of brief pulses with a high clock rate. The actuator element which is slow acting compared to the solenoid valves provides a continuously variable pressure at the input side. The binary valves therefore act as an analogue valve. Solenoid valves which are actuated by pulse width modulation are known to a person skilled in the art so that there is no need to give more details on them at this point.

According to one expedient development, the control unit is an electronic control unit. An electronic control unit comprises, for example, a programmable computer such as are used already in rail-guided vehicles and are provided, for example, for making available protection against skidding.

In contrast to this, the control unit is a nonprogrammable electronic control unit or a pneumatic or hydraulic control unit.

According to one preferred embodiment of the invention, a service brake for braking the vehicle in the normal operating mode and a safety brake for braking the vehicle in the case of danger are provided, wherein the safety brake comprises the control unit, with the result that speed-dependent braking is also made available in the case of the safety brake. According to this preferred development, speed-dependent braking is made available even in the case of safety brakes. Here, the invention starts from the realization that the function of the control unit can be guaranteed with a level of safety which meets even stringent safety requirements. Stringent safety requirements apply, for example, to safety brakes in the field of rail bound vehicles. According to the invention, continuous adaptation of the braking force to the speed of the rail vehicle is also made available for the safety brake.

The actuator element is advantageously a brake cylinder which can be activated pneumatically or hydraulically. The brake cylinder expediently has a boundary wall which is guided in a movable fashion, for example a piston, connected to a piston rod, of a piston cylinder, with the piston, and therefore the piston rod, being connected to the brake lining via an expedient lever mechanism. When there is an increase in pressure within the brake cylinder, the braking force with which the brake lining is pressed against the brake surface is therefore increased.

The brake cylinder is advantageously connected to the outlet of a pressure transmitter which boosts a pilot control pressure as a function of an actuation pressure, wherein the means for continuously adjusting the pressure are configured to adjust the actuation pressure. Pressure transmitters are known, for example, from DE 29 11 074 and they are used where large volume flows make precise control and adjustment of pneumatic or hydraulic pressures difficult. With a pressure transmitter it is possible to control a pressure precisely at the outlet of the pressure transmitter, in which case the control firstly acts only on the actuation pressure which is connected to a much smaller volume flow. In this way, the control of the overall system becomes more precise, and the pilot control circuit can be made of compact design owing to the small cross sections. The actuation pressure expediently boosts a pilot control pressure which is applied to a second inlet of the pressure transmitter. The pressure transmitter expediently has a further inlet which is connected to the pressure supply which makes available the necessary volume flows of hydraulic or pneumatic fluid.

A second control unit is advantageously provided for replacing the control unit in the event of a fault. In this way a redundant control unit is made available.

The second control unit and the first control unit are expediently at different hierarchy levels. Such control units at different hierarchy levels are already known from train control. The control units can therefore easily be integrated into already existing computer systems.

The control unit advantageously adjusts the braking force in inverse proportion to the speed of the vehicle as soon as the vehicle exceeds a threshold speed. As has already been stated in relation to the prior art, the power input p into the brake surface can be described by the equation p=F*v, where F corresponds to the braking force and v corresponds to the speed of the vehicle. If the braking force F is inversely proportional to the speed

$$F = A * \frac{1}{v} ,$$

p=A, where A is a proportionality constant. In this way, the power input p remains constant even at relatively high speeds, and it can be set to a maximum value at which damage to the brake surface is still just avoided, while at the same time the largest possible braking force F is applied to the brake linings.

According to one preferred development of the method according to the invention, the braking force is generated by a safety brake. According to this advantageous refinement of the invention, the safety brake is also configured, together with the service brake, to make available a maximum braking force, while at the same time an excessively large power input into the braking surface is avoided.

Further expedient exemplary embodiments and advantages of the invention are the subject matter of the following description of exemplary embodiments of the invention with reference to the figures of the drawing in which identical figures refer to identical components and in which:

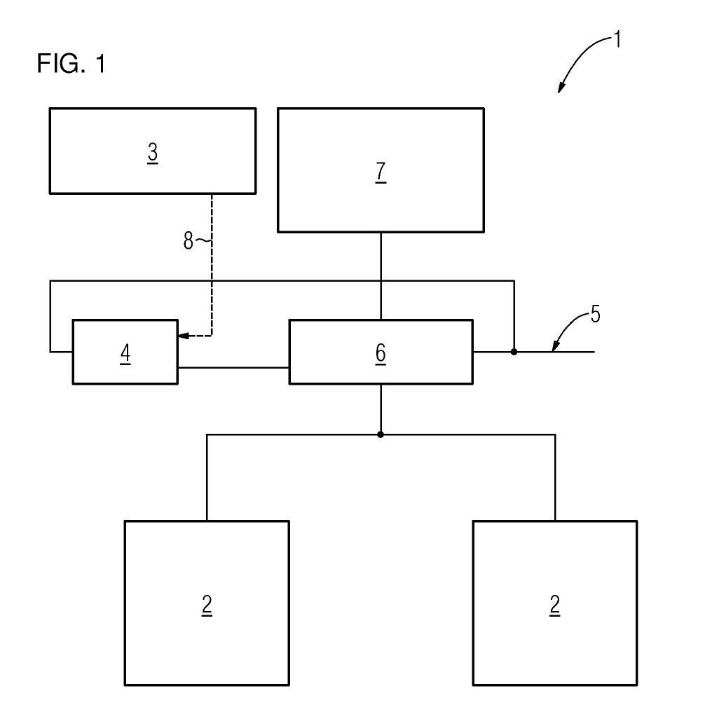

FIG. 1 shows an exemplary embodiment of the brake device according to the invention in a schematic view,

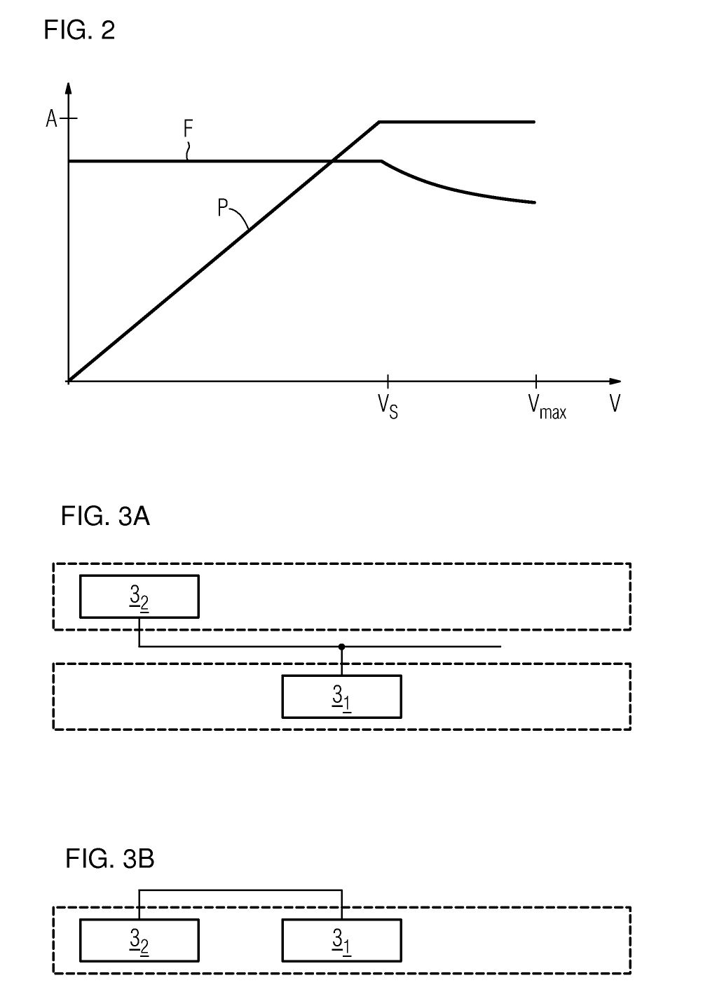

FIG. 2 shows an exemplary embodiment of the control of the braking force F and of the braking power p as a function of the speed of a vehicle and

FIGS. 3a and 3b show control units at the same hierarchy levels and at different hierarchy levels.

FIG. 1 is a schematic view of an exemplary embodiment of the brake device 1 according to the invention. The brake device 1 has a plurality of brake cylinders 2 which are arranged in a bogey (not illustrated in the figure) of a rail bound vehicle. The brake cylinders 2 comprise a brake chamber which can be filled with compressed air and which is bounded in a seal-forming fashion by a movably guided piston. The piston is connected to a piston rod, which is in turn connected to at least one brake lining via an expedient lever mechanism, with each brake lining facing a brake disc. In order to initiate a braking process, pressure is applied to the brake cylinder, or to be more precise to the brake chamber, with the result that the piston which bounds the brake chamber is moved and each brake lining is pressed against the brake disc with frictional locking. The brake disc is connected to a wheel axle (not shown either) so as to rotate with it, with the result that the bogey, and therefore the rail bound vehicle, are decelerated. The deceleration force which is triggered during this braking process is dependent on the pneumatic pressure generated in the brake cylinder. The braking process can therefore be controlled by means of the pressure of the brake cylinder.

A control unit 3 is used to apply a pneumatic pressure to the brake cylinder in a controlled fashion, said control unit 3 interacting with an analogue converter 4 as means for continuously adjusting the pressure, which analogue converter 4 is connected pneumatically to a compressed air supply 5 and to an actuation inlet of a pressure transmitter 6. The pressure transmitter 6 is also connected to a pilot control pressure vessel 7 and it communicates via its outlet with the brake cylinders 2.

In particular in the case of rail vehicles, brake cylinders 2 are necessary which require a correspondingly large volume flow of compressed air in order to generate the necessary braking force.

Since such large volume flows can only be controlled at high cost, the pressure transmitter 6 is provided which boosts the pilot control pressure in proportion to the actuation pressure, said pilot control pressure being applied to the first inlet of said pressure transmitter 6 and being set by the pressure in the pilot control pressure vessel 7. The actuation pressure 4 is determined by the control unit 3 which is connected to the analogue converter 4 via an electrical communication line 8. The analogue converter 4 is, for example, an electro-pneumatic pressure control valve which is best known to a person skilled in the art of braking technology. Said electro-pneumatic pressure control valve has the property of generating a pneumatic pressure which is proportional to an electrical input variable such as, for example, an electrical voltage U. In this context, any desired pressures can be generated. In the exemplary embodiment shown, the control unit 3 is a certified, failsafe computer which, in addition to the brake control described here, also performs further functions during the operation of a rail vehicle. In the exemplary embodiment described here, the computer which comprises the control unit 3 is also configured to make available protection against skidding by means of anti-skid valves (not shown). Said computer is, for example, of redundant design. Alternatively, a nonprogrammable electronic device can also be used as a control unit.

FIG. 2 shows a diagram in which the speed v of a rail vehicle is plotted on the abscissa, and both the braking force F and the braking power p are plotted on the ordinate. It is apparent that a constant pressure, and therefore a constant braking force F, are generated up to a speed of v_{S}. In the illustrated exemplary embodiment, v_{S} is equal to 200 km/h. As the speed v increases, the braking power p which is input into the brake disc also increases continuously up to the switchover speed v_{S}. Above the switchover speed v_{S}, heat damage to the brake disc would be expected if the braking force F were to remain constant. In order to avoid damage to the brake disc and the brake linings, the control unit 3 according to FIG. 1 sets a braking force F which is inversely proportional to the speed. As has already been stated, the relationship p=F*v applies. If

$$F = A * \frac{1}{v} ,$$

a braking power p=A is obtained, where A is a proportionality constant. The braking power p remains constant, and is of just such a magnitude that damage to the frictionally locking elements is avoided.

FIG. 3a clarifies that the control unit 3 is of redundant design. A first control unit 3₁ and a second control unit 3₂ are therefore provided. The first control unit 3₁ is arranged on a first level which is indicated by dotted lines and which is hierarchically below the level of the second control unit 3₂. Such hierarchical structures have become customary, for example, for the control of a rail bound vehicle.

FIG. 3b shows an exemplary embodiment which differs from the exemplary embodiment according to FIG. 3a, with the first control unit 3₁ and the second control unit 3₂ being arranged at a common hierarchy level.

1-16. (canceled)

17. A brake device for braking a vehicle, the braking device comprising:
a brake surface connected to a wheel axle of the vehicle so as to rotate with it;
a brake lining which can be pressed against said brake surface with a braking force;
an actuator element for generating the braking force;
a control unit coupled to said actuator element;
a speed sensor connected to said control unit for sensing a speed of the vehicle;
means for continuously adjusting pressure; and
said control unit configured to adjust the braking force in dependence on the speed of the vehicle, said control unit being coupled to said actuator element via said means for continuously adjusting the pressure, with a result that continuous adaptation of the braking force to a respectively prevailing speed is made possible.

18. The brake device according to claim 17, wherein said means for continuously adjusting the pressure is an analog converter.

19. The brake device according to claim 17, wherein said means for continuously adjusting the pressure has binary solenoid valves which are actuated by pulse width modulation.

20. The brake device according to claim 17, wherein said control unit is an electronic control unit.

21. The brake device according to claim 17, wherein said control unit is selected from the group consisting of a nonprogrammable electronic control unit, a pneumatic control unit and a hydraulic control unit.

22. The brake device according to claim 17, further comprising:
a service brake for braking the vehicle in a normal operating mode; and
a safety brake for braking the vehicle, said safety brake includes said control unit, with a result that speed-dependent braking is also made available in a case of said safety brake.

23. The brake device according to claim 17, wherein said actuator element is at least a brake cylinder which can be activated one of pneumatically and hydraulically.

24. The brake device according to claim 23, further comprising a pressure transmitter having an outlet for boosting a pilot control pressure in dependence on an actuation pressure, said brake cylinder is connected to said outlet of said pressure transmitter, wherein said means for continuously adjusting the pressure is configured to adjust the actuation pressure.

25. The brake device according to claim 17, further comprising a further control unit replacing said control unit in an event of a fault.

26. The brake device according to claim 25, wherein said further control unit and said control unit are at different hierarchy levels.

27. The brake device according to claim 17, wherein said control unit adjusts the braking force in inverse proportion to the speed of the vehicle as soon as the vehicle exceeds a threshold speed.

28. A method for braking a vehicle, which comprises the steps of:
sensing a speed of the vehicle via a speed sensor, and a control unit which is connected to the speed sensor presses, in dependence on the speed, a brake lining with a braking force against a brake surface which is connected to a wheel axle of the vehicle so as to rotate with it; and
adapting continuously the braking force to the speed by means for continuously adjusting a pressure, when a threshold speed is exceeded.

29. The method according to claim 28, which further comprises generating the braking force which is inversely proportional to the speed of the vehicle as soon as the vehicle exceeds the threshold speed.

30. The method according to claim 28, which further comprises using a further control unit which, when the control unit fails, takes the place of the control unit.

31. The method according to claim 30, wherein the further control unit and the control unit are at different hierarchy levels.

32. The method according to claim 28, wherein the braking force is generated by a safety brake.
